(19) United States
(12) Patent Application Publication
(10) Pub. No.: US 2008/0022774 A1
(43) Pub. Date: Jan. 31, 2008

(54) Imaging thin film structures by scanning acoustic microscopy

(75) Inventor: Minhua Lu, Mohegan Lake, NY (US)

Correspondence Address: GRAHAM S. JONES, II, 42 BARNARD AVENUE, POUGHKEEPSIE, NY, 12601-5023, US

(73) Assignee: International Business Machines Corporation

(21) Appl. No.: 11/495,243

(22) Filed: Jul. 28, 2006

(51) Int. Cl. G01N 29/04

(52) U.S. Cl. 73/606

(57) ABSTRACT

A method and apparatus for Scanning Acoustic Microscopy (SAM) for testing of a semiconductor device having a first surface and a second surface with bonding features secured to said first surface are provided. An impervious fixture comprising a dam or a tank retains acoustic transmission fluid in contact with the second surface. Acoustic transmission fluid is excluded from admission to the space surrounding the bonding features where an atmosphere of gas or a vacuum is provided by isolating the first surface from the acoustic transmission fluid either by providing a sealed chamber protecting the first surface or by providing a dam surrounding the second surface.

### BACKGROUND OF THE INVENTION

The present invention relates to the non-destructive inspection of the microscopic structures by acoustic microscopy. More particularly, it is related to the use of Scanning Acoustic Microscopy (SAM) to perform non-destructive imaging of the internal structure of a silicon wafer or semiconductor packaging materials.

Non-destructive inspection of the electronics packaging by acoustic microscopy or x-ray imaging has been widely used in semiconductor industry for quality assurance and failure analysis. In particular, Scanning Acoustic Microscopy (SAM) technology has been widely used for non-destructive inspection in the electronics packaging industry. Non-destructive SAM is an analytic technique using ultrasound waves to detect changes in acoustic impedances in integrated circuits (ICs) and other similar materials. In SAM analysis, pulses of acoustic waves at different frequencies are generated which penetrate various materials and the reflections of the sound wave are collected to produce images which are correlated to disclose the presence of the subsurface structures or defects such as a void or a delamination in an IC device. A particularly effective type of SAM comprises C-mode Scanning Acoustic Microscopy (hereinafter referred to as C-SAM), which is capable of both reflective and through-scan analysis. C-SAM is also non-destructive.

As chip sizes becomes progressively smaller and as the interconnect density therein increases, the demand for enhanced spatial resolution becomes greater and the difficulty in non-destructively differentiating features in the multi-layer structure increases. Typically, the Z-direction resolution for x-ray imaging is quite poor.

The Z-direction resolution of acoustic microscopy is improved, but it remains strongly dependent on differences in acoustic impedances of materials involved in the inspection environment. For example, an acoustic microscope can detect an air void as thin as 500 Å between a bond and a silicon wafer, but it is difficult to differentiate features in a multilayer metal stack with a thickness of a few thousands angstroms.

In a semiconductor C4 (Controlled Collapse Chip Connection) interconnect process, a multilayer metal stack, Ball-Limiting Metallurgy (BLM) or Under Bump Metallurgy (UBM), is used to enhance the adhesion between solder bumps and Si BEOL (Back End Of Line) interconnects.

BLM pads are formed of metal and are conductive. It is conventional to form BLM pads by sputtering or electroplating of metal films which is followed by patterning using selective, chemical etching techniques. In selective etching, the etching chemistries employed can create a serious problem by attacking a BLM pad or UBM structure preferentially thereby reducing the diameter of the UBM and diminishing the mechanical integrity of the C4 bumps attached to the BLM pads. The BLM pads are often over-etched during the process. That is a serious concern because it reduces the degree of reliability of the bonds formed between the elements being processed. Problems referred to as undercutting or over-etching can be caused by fluid flow characteristics in the bath, location in a wafer boat, and etch chemistries. Points on a device where such overetching or undercutting have occurred are points where cracking or delamination of metallic elements involved are likely to be initiated. Thus problems caused by over-etching or undercutting effects are concerns with regard to the reliability of C4 interconnects. Those problems are exacerbated as the density of interconnect structures increases and as the scale of the BLM pads and C4 bumps becomes smaller and smaller. Currently, the detection of the C4 undercutting is done by either chemical un-layering or by making cross sections. Both methods are destructive and time consuming. There is a strong need for a method of non-destructive inspection to avoid destruction and to accelerate the inspection process.

U.S. Pat. No. 6,374,675 of DePetrillo entitled “Acoustic Microscopy Die Crack Inspection for Plastic Encapsulated Integrated Circuits” describes a method for “ . . . non-destructive die crack inspection of a plastic encapsulated integrated circuit (PEIC) uses a scanning acoustic microscope, such as a C-mode scanning acoustic microscope. To generate scan of a die surface of the PEIC, the width of a data gate of the microscope is set to scan only the die surface. Then, the data gate is moved to cover only die subsurface reflection area on a screen of the microscope, and scan of the die subsurface is generated.”

U.S. Pat. No. 7,000,475 of Oravecz et al entitled “Acoustic Micro Imaging Method and Apparatus for Capturing 4D Acoustic Reflection Virtual Samples” which shows and describes C-SAM, states as follows:

“In C-Mode scanning acoustic microscopy a focused spot of ultrasound is generated by an acoustic lens assembly at frequencies typically in the range of 10 MHz to 200 MHz or more. The ultrasound is conducted to the sample by a coupling medium, usually water or an inert fluid. The angle of the rays from the lens is generally kept small so that the incident ultrasound does not exceed the critical angle of refraction between the fluid coupling and the solid sample. The focal distance into the sample is shortened by the refraction at the interface between the fluid coupling and the solid sample.”

“The transducer alternately acts as sender and receiver, being electronically switched between transmit and receive modes. A very short acoustic pulse enters the sample, and return acoustic reflectances are produced at the sample surface and at specific impedance interfaces and other features within the sample. The return times are a function of the distance from the encountered impedance feature to the transducer and the velocity of sound in the sample material(s).”

“An oscilloscope display of the acoustic reflectance pattern (the A scan) will clearly show the depth levels of impedance features and their respective time-distance relationships from the sample surface.”

“This provides a basis for investigating anomalies at specific levels within a part. The gated acoustic reflectance amplitude is used to modulate a CRT that is one-to-one correlated with the transducer position to display reflectance information at a specific level in the sample corresponding to the position of the chosen gate in time.”

“With regard to the depth zone within a sample that is accessible by C-scan techniques, it is well known that the large acoustic reflectance from a liquid/solid interface (the top surface of the sample) masks the small acoustic reflectances that may occur near the surface within the solid material. This characteristic is known as the dead zone, and its size is usually of the order of a few wavelengths of sound.”

“Far below the surface, the maximum depth of penetration is determined by a number of factors, including the attenuation losses in the sample and the geometric refraction of the acoustic rays which shorten the lens focus in the solid material. Therefore, depending upon the depth of interest within a sample, a proper transducer and lens must be used for optimum results.”

“In C-Mode scanning acoustic microscopy (“C-SAM”), contrast changes compared to the background constitute the important information. Voids, cracks, disbonds, and other impedance features provide high contrast and are easily distinguished from the background. Combined with the ability to gate and focus at specific levels, C-SAM is a powerful tool for analyzing the nature of any acoustic impedance feature within a sample.”

“In this type of C-mode scanning, the A-scan for each point interrogated by the ultrasonic probe is discarded except for the image value(s) desired for that pixel. Two examples of image value data are: (a) the peak detected amplitude and polarity, or (b) the time interval from the sample's surface echo to an internal echo (the so-called “time-of-flight” of “TOF” data).”

In acoustic microscopy, water has been used to transmit acoustic waves from a transducer generating acoustic vibrations and a sample being inspected and to transmit return acoustic vibrations from the sample being inspected to an acoustic transducer, e.g. a microphone. Typically, acoustic microscopes are equipped within a water tank. A sample to be inspected is placed in the water tank during the scan.

FIG. 1A illustrates a schematic, sectional elevation of an isolated element of a prior art C-SAM testing arrangement 10 including a tank 11 filled with water 12. An oversimplified version of a device 13 is located inside the tank 11 where it is shown completely immersed in the water 12. The device 13 includes a silicon wafer 14 (greatly reduced in scale for convenience of illustration) having a back surface B and an inverted front surface F on which a greatly magnified example of only a single conductive Ball Limiting Metallurgy (BLM) pad 15 is formed. The BLM pad 15 is composed of one or multi-layer metal films. In the conventional manner, a greatly magnified example of only a single C4 bump 16 composed of solder (having a lower melting point than the pad 15) is shown bonded to the inverted top surface of the BLM pad 15.

Since the device 13 is completely immersed in the water 12, the water 12 is in contact with the exposed edges of the BLM pad 15 and the C4 solder bump 16. A scanning C-SAM transducer 17 is shown above the wafer 14 with its lower end proximate to the back surface B of the silicon wafer 14 for providing a C-SAM scan of device 13.

FIG. 3A shows a C-SAM image of the results of a test employing a prior art testing arrangement and a prior art testing method of a sample similar to the sample of FIG. 1A with multiple C4 bumps and multiple BLM pads immersed in water of a multiple C4 device similar to the single C4 device 10 of FIG. 1A. Due to the small differences in acoustic impedance between the solder and BLM pad and the surrounding water, the C-SAM image of the multiple C4s and BLM pads in FIG. 3A is fuzzy.

FIG. 1B illustrates a prior art testing arrangement 10 which is a modification of the testing arrangement 10 in FIG. 1A, with the device shown after chip joining, but before underfill. In FIG. 1B a scanning C-SAM transducer 17 scans a device 13′ being tested which includes a silicon wafer 14′ with a BLM pad 15′ and a C4 bump 16′ which both have a crack 19 formed therein. Thus, since the device 13′ is immersed in water, both the BLM pad 15′ and the C4 bump 16′ have internal surfaces along the crack 19, which are filled with water 12. Moreover, the BLM pad 16′ has become delaminated from the front F of the silicon wafer 14′ and the top surface of the C4 bump 16′ is bonded to a conducting pad 8 on a substrate 18 below the C4 bump 16′. Since the crack 19 in the solder bump 16′ and the pad 15′ and the interface with the BLM solder pad 15′ are filled with water 12, and since the water 12 is a good transmitter of acoustic waves, the crack 19 cannot be detected by C-SAM microscopy. It should be noted that the substrate 18 can be a laminate or a ceramic substrate.

FIG. 4A shows a C-SAM image of the results of a test employing a prior art testing arrangement and a prior art testing method of a sample similar to the sample of FIG. 1B with several solder interfaces with multiple C4 bumps and multiple BLM pads with cracks in solder immersed in water of a multiple C4 device similar to the multiple C4 device 23 of FIG. 1C.

FIG. 1C shows a modified prior art C-SAM testing arrangement 20 including a tank 11′ filled with water 22. A larger sample 23 (i.e. the device under test) housed in tank 11′ is being tested; and, as in FIGS. 1A and 1C, the sample 23 is completely immersed in the water 12. The device 23 includes a silicon wafer 24 (reduced in scale for convenience of illustration) having an inverted front surface F on which a plurality of conductive BLM pads 25 are formed. In the conventional manner, each of a set of four C4 solder bumps 26 is shown bonded to the inverted top surface of one of the conductive BLM pads 25. A C-SAM transducer 17 is shown above the wafer 24 with its lower end proximate to the back surface B of the silicon wafer 24. As stated above, there is a significant problem with immersion in the water 22 of a device under test for inspection by a C-SAM testing apparatus. The problem is that water is an excessively good transmitter of acoustic waves. A crack 29 is shown in one of the BLM pads 25 extending through the C4 solder bump 26 bonded thereto; and as with FIG. 1B, since the crack 29 in the solder bump 26 and the BLM pad 25 is filled with water 22, and since the water 22 is a good transmitter of acoustic waves, the crack 29 cannot be detected by C-SAM microscopy. Since there is very little impedance difference between the water 22 and the BLM pads 15 and the C4 bumps 16 is small, the location of the BLM boundary can not be clearly distinguished in the C-SAM image.

As shown in FIG. 1C, the top surface of the C4 solder bump 26, is in contact with the BLM 25. The BLM 25 is adapted to facilitate the electrical and physical connection of the admixture of solder with another object such as the semiconductor wafer 24. The BLM can be formed by any means known in the art as long as the necessary electrical and/or physical connection between the first object and the admixture of solder exists. The BLM 25, which is in electrical communication with the wafer 24, can be formed and/or deposited by any means known in the art such that it can function with the first object. The device under test can be a chip joined to a substrate through C4 solder bumps attached to proper conducting pads on chip and substrate for electrical connections. A C-SAM transducer 17 is shown above the wafer 24 with its lower end just above the back surface B of the silicon wafer 24. In order to differentiate a 2-10 μm or less undercut of a metal pad that is 0.5 μm or less in thickness and 75-150 μm in diameter from a solder bump and interconnecting wires juxtaposed therewith is pushing into the limit of the current Scanning Acoustic Microscopy (SAM) technology. The edge effect attributable to the scattering of the acoustic waves introduces additional error in measurement. The contrast of the acoustic image depends on the differences in the acoustic impedance of the adjacent materials. The small difference in acoustic impedance in the material reduces contrast. There is very little difference in contrast between the thin film stack and the solder. As a typical practice of acoustic microscopy imaging, the sample is immersed in water.

In summary, it has been found that there is a significant problem with immersing a sample to be inspected by a C-SAM testing apparatus in water 22. The problem is that water 22 is a good transmitter of acoustic waves. Since the impedance difference between water 22 and BLM pads 25 and bumps 26 is small, the location of the BLM boundary can not be clearly distinguished in the acoustic image. Using typical SAM imaging procedures in which the sample 33 is immersed in water 22 cannot obtain clearly distinguishable imaging of metal pads 25.

### SUMMARY OF THE INVENTION

In accordance with this invention, a method and apparatus are provided for enhancing the contrast of BLM pad from the surrounding structure to reveal the undercut by acoustic micro-imaging. A set of C4 solder bumps is formed on the front surface of a silicon wafer. The silicon wafer is placed with front, C4 bump side down with the obverse, back surface (flat) of the silicon wafer facing to the transducer of a scanning acoustic microscopy (SAM) apparatus. Although the space between the obverse surface of the wafer and transducer is filled with water, the acoustic couplant, the C4 bump size of the wafer is secluded in an environment of a gas (air) or vacuum. Barriers are provided surrounding the BLM and solder bumps to form a space which is a vacuum or air filled space defined by those barriers to separate the water in the immersion tank from the space formed by the barriers. In other words, the vacuum or gas (air) surrounds the BLM and solder bumps and fills each gap caused by an undercut or crack without the intrusion of water or liquid. Because of the low acoustic impedance of the gas or a vacuum, a large portion of the acoustic waves is reflected back to the acoustic microscopy device. The larger difference in the acoustic impedance between the C4 structure and the gas, especially at the vicinity of the undercut gap or cracks, enhances the contrast and reveals an undercut gap or crack that was invisible when the device under test is immersed in water. The advantage of the invention is ability of the non-destructive detection and accurate measurement of the BLM undercut or cracks. The time consuming and expensive destructive methods, such as cross-sectioning and chemical un-layering are avoided.

In accordance with this invention, apparatus for Scanning Acoustic Microscopy (SAM) of a semiconductor device, with the semiconductor device having a first surface and a second surface with bonding features secured to the first surface us provided. It comprises a container for retaining acoustic transmission fluid in contact with the second surface with the bonding features. A chamber surrounds the first surface. The chamber has an interior space filled with an atmosphere selected from a gas and a vacuum and being sealed to prevent the acoustic transmission fluid from being admitted into the interior space. An acoustic scanning probe of a SAM is positioned confronting the second surface of the semiconductor device.

Preferably, the bonding features comprise Ball-Limiting Metallurgy (BLM) pads and solder bonding elements. Preferably, the bonding features comprise Ball-Limiting Metallurgy (BLM) pads, solder bonding elements and a substrate. Preferably, the container includes a sealed chamber secured to the first surface of the semiconductor device with forming a gas chamber separating the bonding features from the acoustic transmission fluid. Preferably, the acoustic transmission fluid comprises water, and the container includes a sealed chamber secured to the first surface of the semiconductor device with the sealed chamber comprising a gas filled chamber separating the bonding features from the water.

Preferably, the acoustic transmission fluid comprises water, and the container includes a sealed vacuum chamber secured to the first surface of the semiconductor device with the sealed vacuum chamber separating the bonding features from the water. Preferably, the acoustic transmission fluid comprises water, and the container includes an impervious, physical barrier secured to the first surface of the semiconductor device separating the bonding features from the water.

In accordance with another aspect of the invention, apparatus for Scanning Acoustic Microscopy (SAM) of a semiconductor device having a first surface and a second surface with bonding features secured to the first surface comprises a tank for retaining acoustic transmission fluid. An impervious fixture is retained in sealed contact with the first surface defining an interior space surrounding the bonding features, the impervious fixture being filled with an atmosphere of gas and being sealed to exclude the acoustic transmission fluid from admission to the interior space.

In accordance with still another aspect of this invention a method of testing a semiconductor device employs Scanning Acoustic Microscopy (SAM) of a semiconductor device having a first surface and a second surface with bonding features secured to the first surface. The steps involve retaining acoustic transmission fluid in a container in contact with the second surface; providing a chamber surrounding the first surface, the chamber having an interior space filled with an atmosphere selected from an atmosphere of gas and a vacuum with the chamber being sealed to prevent the acoustic transmission fluid from being admitted into the interior space; and positioning a SAM acoustic scanning probe confronting the second surface of the semiconductor device extending into the acoustic transmission fluid.

Preferably, the container includes a sealed chamber secured to the first surface of the semiconductor device forming a gas chamber separating the bonding features from the acoustic transmission fluid.

In an aspect of this invention, the acoustic transmission fluid comprises water, and the container includes a sealed chamber secured to the first surface of the semiconductor device with the sealed chamber comprising a gas filled chamber separating the bonding features from the water.

Preferably, the acoustic transmission fluid comprises water, and the container includes a sealed vacuum chamber secured to the first surface of the semiconductor device with the sealed vacuum chamber separating the bonding features from the water.

Preferably, provide a tank for retaining acoustic transmission fluid; provide an impervious fixture retained in sealed contact with the first surface defining the interior space and surrounding the bonding features filled with an atmosphere of gas and excluding the acoustic transmission fluid from admission to the interior space.

Preferably, the bonding features comprise Ball-Limiting Metallurgy (BLM) pads, solder bonding elements alone or with a substrate.

The invention and objects and features thereof will be more readily apparent from the following detailed description and appended claims when taken with the drawings.

### BRIEF DESCRIPTION OF THE DRAWINGS

The foregoing and other aspects and advantages of this invention are explained and described below with reference to the accompanying drawings, in which:

FIG. 1A is a schematic, sectional elevation of a prior art C-SAM testing arrangement showing a silicon wafer with C4 bumps immersed in water.

FIG. 1B illustrates a prior art testing arrangement which is a modification of the testing arrangement in FIG. 1A, with the device under test shown after chip joining, but before underfill with a BLM pad and C4 bump shown with a crack formed therein.

FIG. 1C shows a modified prior art C-SAM testing arrangement including a tank filled with water with a larger sample being tested immersed in the water. A set of four C4 bumps are shown bonded to conductive BLM pads with a crack in one of the BLM pads extending through the C4 bump bonded thereto.

FIG. 2A is an illustration of sample setup in accordance with the present invention wherein C-SAM acoustic microscopy is performed by immersion of a Device Under Test (DUT) in water to couple acoustic energy to the back surface of the device under test while isolating the front portion of the device under test including multiple C4 solder bumps bonded to multiple BLM pads in a dry environment in a sealed chamber protected from the water in which the device under test is immersed with a solid plate and a gasket sealed to the C4 solder bump side of the wafer to maintain the BLM pads and C4 solder bumps enveloped in air.

FIG. 2B is an illustration of a modification of the sample setup in FIG. 2A in accordance with the present invention, wherein multiple BLM pads and C4 solder bumps are isolated in a dry environment in a sealed chamber isolated from the water with the sealed chamber being evacuated through a vacuum line connected to the sealed chamber for evacuation of gas and/or air therefrom.

FIG. 2C is an illustration of sample setup in accordance with the present invention wherein C-SAM acoustic microscopy is performed by partial immersion of the back surface of a device under test by forming a dam filled with water thereover to couple of acoustic energy from a SAM probe to the back surface of the device under test while maintaining the front surface of the device under test including multiple BLM pads bonded to multiple C4 solder bumps in a dry environment isolated from the water in which the back surface of the device under test is immersed.

FIG. 3A shows a C-SAM image of the results of a test employing a prior art testing arrangement and a prior art testing method of a sample similar to the sample of FIG. 1C with several solder interfaces with multiple C4 bumps and multiple BLM pads with cracks in solder immersed in water of a multiple C4 device similar to the single C4 device of FIG. 1C.

FIG. 3B shows a C-SAM image of the results of 2a testing arrangement employing the method of this invention employing C-SAM acoustic microscopy with fluid coupling of acoustic energy to a surface of a device under test. The device includes dry multiple BLM pads bonded to multiple C4 solder bumps solder with the device being scanned while immersed in water which the BLM bumps and C4s maintained in a dry environment by isolation from the water in which the device is immersed.

FIG. 4A shows a C-SAM image of the results of a test employing a prior art testing arrangement and a prior art testing method of a sample similar to the sample of FIG. 1B with several solder interfaces with multiple C4 bumps and multiple BLM pads with cracks in solder immersed in water of a multiple C4 device similar to the single C4 device of FIG. 1C.

FIG. 4B is an acoustic microscope image of the same sample scanned with the BLM pad and C4 solder interface kept dry on the inverted top surface of the silicon substrate with the bottom surface of the wafer confronting the C-SAM acoustic probe immersed in water.

FIG. 5 is a C-SAM image performed in accordance with the method of this invention of a semiconductor wafer with a severe undercut.

FIG. 6 is a C-SAM image performed in accordance with the method of this invention of another semiconductor wafer with less undercut.

FIG. 7 is comparison of the measurement of 30 BLM pads employing the C-SAM method of this invention with the prior art method of taking measurements employing an optical microscope image after chemical unlayering.

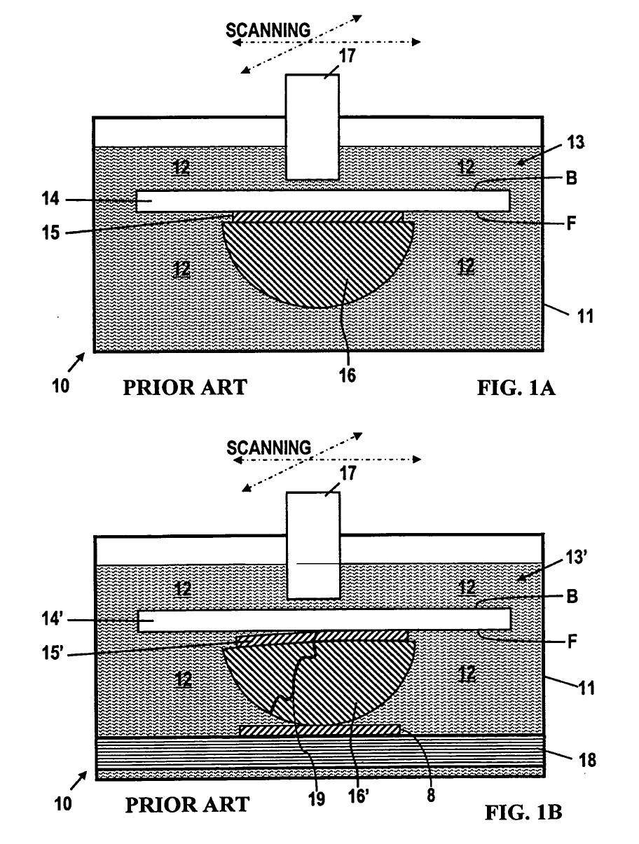

### DETAILED DESCRIPTION OF THE PREFERRED EMBODIMENT

### First Embodiment

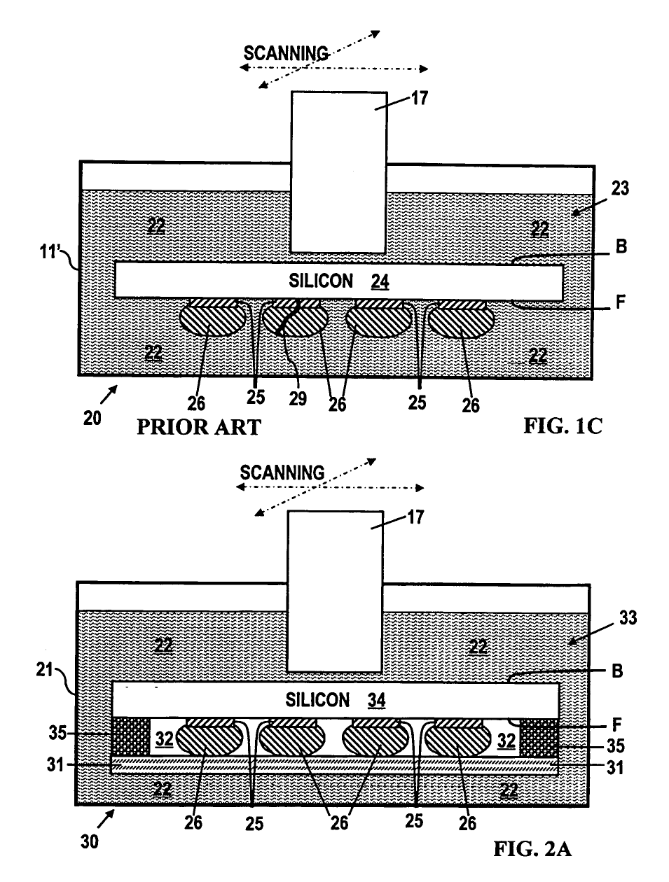

FIG. 2A is an illustration of sample setup in accordance with the present invention wherein C-SAM acoustic microscopy is performed by immersion of a Device Under Test (DUT) 33 in water 22 to couple of acoustic energy to the back surface B of the device 33 while isolating the front portion F of the device 33 including multiple C4 solder bumps 26 bonded to multiple BLM pads 25 in a, sealed, dry 32 protected from the water 22 in which the device 33 is immersed with a solid plate 31 and a gasket 35 sealed to the C4 solder bump (front) side F of the device 33 to maintain the BLM pads and C4 solder bumps enveloped in environment of air in chamber 32.

In particular, in FIG. 2A an acoustic microscope is employed in a configuration in accordance with this invention comprising a C-SAM testing arrangement 30 including a tank 21 filled with water 22. The testing apparatus shown in FIG. 2A is provided for testing a device 33 which includes a silicon wafer 34. The device 33 is immersed in the water 22 retained in the tank 21, but only partially exposed to the water 22. The device 33 includes a silicon, semiconductor wafer 34 (reduced in scale for convenience of illustration) having an inverted front surface F on which a row of conductive BLM pads 25 are formed. In the conventional manner, a single C4 bump 26 is bonded to the inverted top surface of each one of the conductive BLM pads 25. A C-SAM transducer 17 is shown above the silicon wafer 34 with its lower end just above the bottom surface B of the wafer 34.

As stated above, there has been a significant problem with total water immersion of a sample to be inspected by a C-SAM testing apparatus in water. The problem is that the water 22 is a good transmitter of acoustic waves. Since the impedance difference between the water 22 and BLM pads 15 and bumps 16 is very small, the location of the BLM boundary can not be clearly distinguished in the acoustic image. However, in FIG. 2A, although the wafer 34 is immersed in the water 22, the BLM pads 25 and the C4 bumps 26 have been isolated from the water 22 in the tank 21 in a sealed chamber 32 by an impervious barrier structure. The barrier structure comprises a solid or water tight plate or membrane 31 and an impervious gasket 35. The impervious gasket 35 may be composed of an elastomer or rubber. The solid or water tight plate or membrane 31 is sealed to the gasket 35 and the gasket 35 is sealed to the wafer 34 and adherently (e.g. glued) or secured (e.g. retained in placed by a jig) to the front surface F (bumps side) of the wafer 34 to protect the C4 bumps 25 and BLM pads 15 from the water 22. The sealed chamber 32 is defined by the solid or water tight plate or membrane 31 and the water tight gasket 35. Since the chamber 32 is filled with air, which has a far lower density than that of the water 22, the transmission of acoustic vibration energy therethrough is greatly reduced. Typical sizes of BLM pads 15 and C4 bumps 24 are about 25-500 μm, typically 50-150 μm. The acoustic frequency of the transducer 17 is from 15 MHz to 2 GHz, typically 50 MHz to 300 MHz.

The device under test can be a silicon wafer, silicon wafer with BLM pads, silicon wafer with BLM pads and solder, or a module where silicon chip is joined to a substrate through C4s arrays.

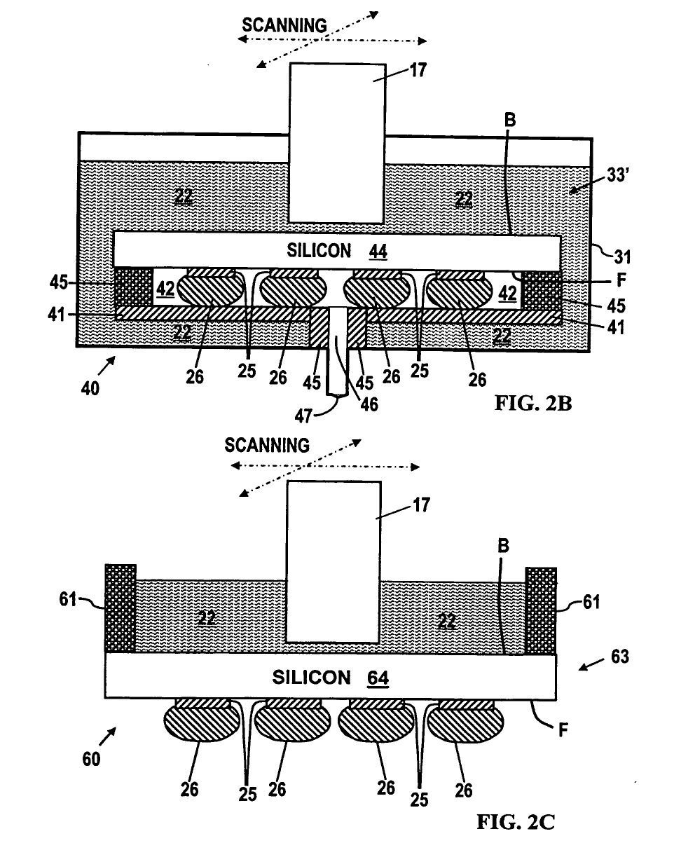

FIG. 3B is a C-SAM image at a BLM and solder interface level, using the same parameters as used to provide the image shown in FIG. 3A. Comparing the two images of FIG. 3A and FIG. 3B, FIG. 3B shows clear defined images of the boundary BLM pads; while the image of the BLM pads in FIG. 3A is fuzzy. In the configuration FIG. 2A, the BLM pads 25, and the C4 solder bumps 26 are surrounded in space 32 by air, which has substantially lower acoustic impedance than that of the water 22. More importantly, an undercut gap in a BLM 25 due to over etching is now filled with air. The impedance difference between the air gaps in the thin narrow undercut is large enough for the acoustic microscope to reveal the thin metal layer with the undercut in the multi-layer thin film stack, so that the degree of under cut can be measured.

### Second Embodiment

FIG. 2B is an illustration of a modification of the sample setup in FIG. 2A in accordance with the present invention, wherein multiple BLM pads 25 and multiple C4 solder bumps 26 are isolated in a dry environment within a sealed enclosure 42. In other words, the C4 solder bumps 26 and BLM pads 25 are isolated from the water 22. The sealed enclosure 42 is evacuated through a vacuum line 47 connected to the sealed enclosure 42. In FIG. 2B the seal to the front surface F of the silicon, semiconductor wafer 44 is retained in place by a vacuum chuck so the solder bumps 26 and BLM pads 25 remain in vacuum, isolated from water 22, during scanning. Sound waves are substantially blocked from being transmitted by the very high impedance of a partial vacuum, and are substantially completely reflected back to the interface.

The provision of a vacuum within the enclosure 42 is an improvement over the air provided in FIG. 2A, because the higher impedance of the vacuum will transmit almost no energy and will increase the contrast and reveal the small cracks and undercut gap that are not clearly visible when the space near the interface is filled with air or especially when it is filled with water.

In FIG. 2B the device 33′ is arranged in a modified water tank 31 in a similar manner to that seen in FIG. 2A. The lower end of the C-SAM transducer 17 is shown just above the back surface B of the silicon semiconductor wafer 44. A row of BLM pads 25 and C4 bumps 26 are shown secured to the front surface F of the wafer 44. There some differences from FIG. 2A with regard to isolation of the row of conductive BLM pads 25 and the C4 bumps 26 from the water 22. Again although the wafer 44 is immersed in the water 22, the BLM pads 25 and the C4 bumps 26 are isolated from the water 22 in the tank 31 by a different form of barrier structure.

The barrier structure of FIG. 2B comprises a metal plate 41 and an impervious gasket 45 (composed of an elastomer or rubber) which are secured adherently (e.g. glued or held by a jig) to the front surface F (bumps side) of the wafer 44 to protect the C4 bumps 26 and BLM pads 25 from the water 22. Moreover, an exhaust line fitting 45 through the bottom of the tank 31 and the bottom of the metal plate 41 is secured to a vacuum exhaust line 47. Line 47 is adapted to be connected to a vacuum pump (not shown for convenience of illustration.) In this way as air or gas is evacuated through passageway 46, a vacuum can be maintained in the interior space 42 surrounding the C4 bumps 26 and BLM pads 25 thereby further increasing the difference in density of the material within the space 42 from the density of the water 22 and reducing the acoustic transmission of energy through the space 42 to nearly zero.

Alternatively, the device under test 33′ can be a silicon wafer, silicon wafer with BLM pads, silicon wafer with BLM pads and solder, or a module where silicon chip is joined to a substrate through C4s arrays. As above, typical sizes of BLM pads 25 and C4 bumps 26 are about 25-500 μm, typically 50-150 μm and the acoustic frequency of the transducer 17 is from 15 MHz to 2 GHz, typically 50 MHz to 300 MHz.

### Third Embodiment

FIG. 2C is an illustration of sample setup in accordance with the present invention wherein C-SAM acoustic microscopy is performed by partial immersion of a device 63. That is achieved by forming a dam retaining a sufficient depth of water 22 above the back surface B of a device 63 to couple of acoustic energy from the bottom end of the SAM probe 17 to the back surface B of the device 63. The inverted front surface F of the device 63 (including the multiple BLM pads 25 which are bonded to multiple C4 solder bumps 26) is located in a dry, open air environment isolated from the water 22. In summary, in FIG. 2C, the dam 61, and the back B of the substrate 64 included in the device 63 form a container above the substrate 64 wherein water 22 is confined.

The water 22 is deep enough to covers the bottom end of the transducer 17. The dam 61 comprises an impervious, physical barrier 61 on the periphery of the back surface B of the substrate 64. The physical barrier 61 may comprise a gasket 61 (composed of an elastomer or rubber.) The front surface F of the substrate 64 and the pads 25 and bumps 26 are located in open air isolated from the water 22. As above, typical sizes of BLM pads 25 and C4 bumps 26 are about 25-500 μm, typically 50-150 μm and the acoustic frequency of the transducer 17 is from 15 MHz to 2 GHz, typically 50 MHz to 300 MHz.

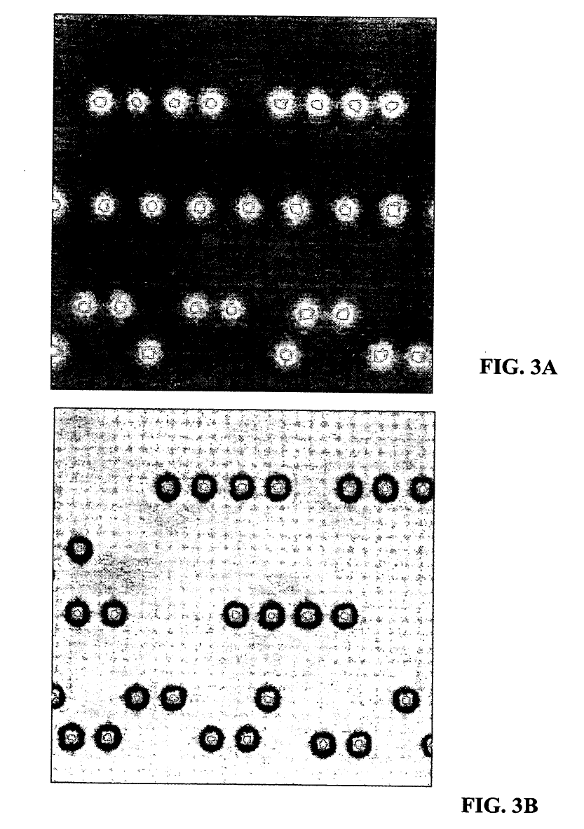

Alternatively a meniscus force can be employed to retain the water 22 in place, which is how the image shown in FIG. 4B was produced.

In the configuration shown in FIG. 2C, the BLM pads 25, and the C4 solder bumps 26 are surrounded in the open by ambient air which has a substantially lower acoustic impedance than the acoustic impedance of the water 22 thereabove. Again, an undercut gap in a BLM 25, due to over etching, is now filled with air. The impedance difference between the air gaps in the thin narrow undercut is large enough for the acoustic microscope to reveal the thin metal layer with the undercut in the multi-layer thin film stack, so that the degree of under cut can be measured. The device under test can be a silicon wafer, silicon wafer with BLM pads, silicon wafer with BLM pads and solder, or a module where silicon chip is joined to a substrate through C4s arrays.

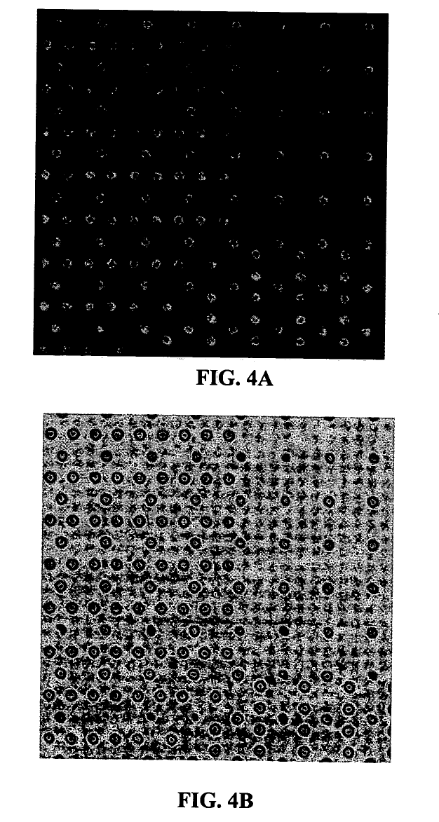

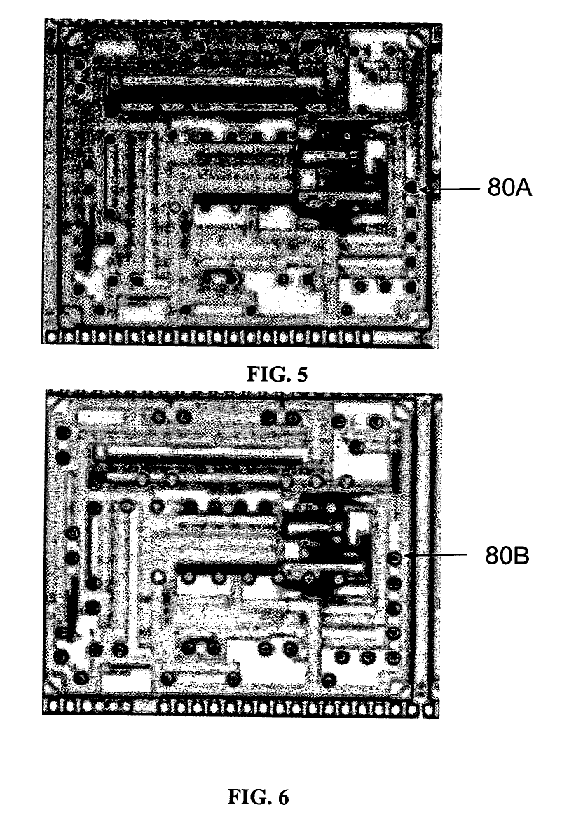

FIG. 5 is C-SAM image of a sample with severe overetch that results in a large undercut 80A and FIG. 6 is a C-SAM image of a sample with less overetch and with less undercut 80B.

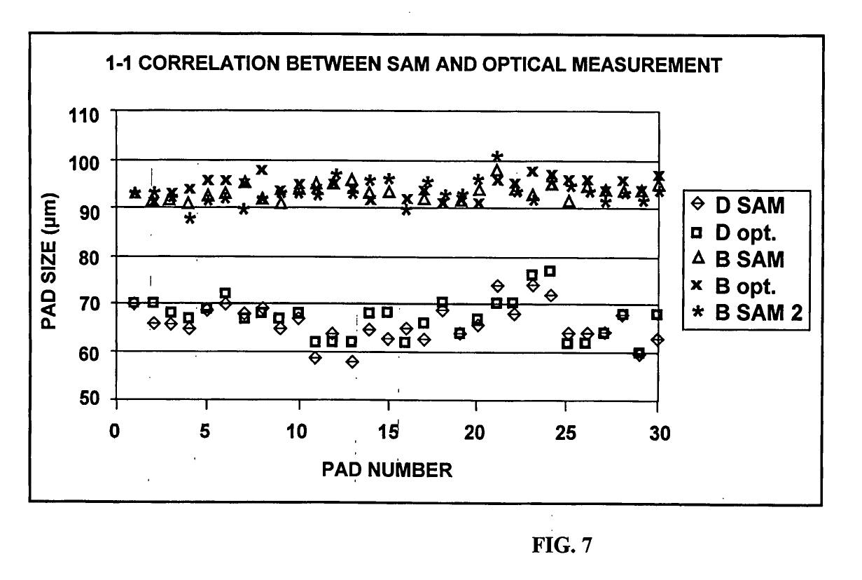

FIG. 7 is the comparison of the measurement of 30 BLM pads using the C-SAM method in accordance with this invention with optical microscope image after chemical un-layering. It showed that the acoustical and pad size measurements were within 1 μm.

It should be understood that the foregoing description is only illustrative of the invention. Various alternatives and modifications can be devised by those skilled in the art without departing from the invention. Accordingly, the present invention is intended to embrace all such alternatives, modifications, and variances which fall within the scope of the appended claims.

What is claimed is:

1. Apparatus for Scanning Acoustic Microscopy (SAM) of a semiconductor device with an acoustic probe, said semiconductor device including a substrate having a first surface and a second surface with bonding features secured to said first surface and with acoustic transmission fluid retained in contact with said second surface; said apparatus comprising:
an environment surrounding said first surface, said environment comprising an atmosphere selected from a gas and a vacuum;
a barrier in contact with one of said first surface and said second surface sealed to prevent said acoustic transmission fluid from being admitted to said environment surrounding said first surface; and
an acoustic scanning probe positioned confronting said second surface of said semiconductor device extending into said acoustic transmission fluid retained in contact with said second surface.

2. The apparatus of claim 1 wherein said bonding features comprise Ball-Limiting Metallurgy (BLM) pads and solder bonding elements.

3. The apparatus of claim 1 wherein said bonding features comprise Ball-Limiting Metallurgy (BLM) pads, solder bonding elements and a substrate.

4. The apparatus of claim 1 including a sealed chamber secured to said first surface of said semiconductor device with said sealed chamber isolating said bonding features from said acoustic transmission fluid.

5. The apparatus of claim 4 wherein said bonding features comprise Ball-Limiting Metallurgy (BLM) pads and solder bonding elements.

6. The apparatus of claim 4 wherein said bonding features comprise Ball-Limiting Metallurgy (BLM) pads, solder bonding elements and a substrate.

7. The apparatus of claim 1 wherein:
said acoustic transmission fluid comprises water, and
a sealed chamber is secured to said first surface of said semiconductor device with said sealed chamber comprising a gas filled chamber separating said bonding features from said water.

8. The apparatus of claim 7 wherein said bonding features comprise Ball-Limiting Metallurgy (BLM) pads, solder bonding elements and a substrate.

9. The apparatus of claim 1 wherein
said acoustic transmission fluid comprises water, and
a sealed vacuum chamber is secured to said first surface of said semiconductor device with said sealed vacuum chamber separating said bonding features from said water.

10. The apparatus of claim 9 wherein said bonding features comprise Ball-Limiting Metallurgy (BLM) pads and solder bonding elements.

11. The apparatus of claim 1 including an impervious, physical barrier secured to one of said first surface and said second surface of said semiconductor device separating said bonding features from said acoustic transmission fluid.

12. The apparatus of claim 11 wherein said bonding features comprise Ball-Limiting Metallurgy (BLM) pads, solder bonding elements and a substrate.

13. Apparatus for Scanning Acoustic Microscopy (SAM) of a semiconductor device having a first surface and a second surface with bonding features secured to said first surface comprising:
a tank for retaining acoustic transmission fluid;
an impervious fixture retained in sealed contact with said first surface defining an interior space surrounding said bonding features, said impervious fixture being filled with an atmosphere selected from the group consisting of a vacuum, air and gas and being sealed to exclude said acoustic transmission fluid from admission to said interior space.

14. A method of testing a semiconductor device employing Scanning Acoustic Microscopy (SAM) of a semiconductor device having a first surface and a second surface with bonding features secured to said first surface comprising:
retaining acoustic transmission fluid in contact with said second surface;
providing a atmosphere surrounding said first surface, said atmosphere being selected from the group consisting air, gas, and a vacuum and separating said acoustic transmission fluid from said atmosphere surrounding said first surface; and
positioning a SAM acoustic scanning probe confronting said second surface of said semiconductor device extending into said acoustic transmission fluid.

15. The method of claim 14 including providing a sealed chamber secured to said first surface of said semiconductor device separating said bonding features from said acoustic transmission fluid.

16. The method of claim 14 wherein:
said acoustic transmission fluid comprises water, and
providing a sealed chamber secured to said first surface of said semiconductor device with said sealed chamber separating said bonding features from said water.

17. The method of claim 14 wherein:
said acoustic transmission fluid comprises water, and
providing a sealed vacuum chamber secured to said first surface of said semiconductor device with said sealed vacuum chamber separating said bonding features from said water.

18. The method of claim 14 including:
providing a tank for retaining acoustic transmission fluid;
providing an impervious fixture retained in sealed contact with said first surface defining an interior space and surrounding said bonding features filled with an atmosphere selected the group consisting of a vacuum, air and gas, and
excluding said acoustic transmission fluid from admission to said interior space.

19. The method of claim 14 wherein said bonding features comprise Ball-Limiting Metallurgy (BLM) pads and solder bonding elements.

20. The method of claim 14 wherein said bonding features comprise Ball-Limiting Metallurgy (BLM) pads, solder bonding elements and a substrate.
